(19) United States
(12) Patent Application Publication
(10) Pub. No.: US 2020/0133439 A1
(43) Pub. Date: Apr. 30, 2020

(54) CHAT SESSION DYNAMIC USER INTERFACE

(71) Applicant: INTERNATIONAL BUSINESS MACHINES CORPORATION, ARMONK, NY (US)

(72) Inventors: Craig M. Trim, Ventura, CA (US); AHMED Nassar, Pflugerville, TX (US); VICTOR POVAR, Vancouver (CA); Sarbajit K. Rakshit, Kolkata (IN)

(21) Appl. No.: 16/176,004

(22) Filed: Oct. 31, 2018

(51) Int. Cl. G06F 3/0481; H04L 12/58

(52) U.S. Cl. CPC G06F 3/0481; H04L 51/04; H04L 51/38; H04L 51/16

(57) ABSTRACT

Aspects of the present invention provide devices that identify a conversation in a chat session between a plurality of computing devices, wherein the conversation is defined by text messages that include a question and a plurality of responses to the question, analyze content of the identified conversation to determine a type of the question, select a template according to the type of question, generate a user interface display according to the selected template and the content of the conversation, wherein the selected template is populated with a summary of the plurality of responses, and distribute the generated user interface display to a user interface of each of the plurality of computing devices according to the selected template.

### BACKGROUND

The field of computing includes real-time transmission of text messages between computing devices and the display of exchanged real-time text messages on the computing devices.

Online chat includes the real-time transmission of the text messages between a sending device and one or more receiving computing devices, such as smartphones. The exchange of the text messages between the computing devices form a chat session. The chat session can last for days, include hundreds or thousands of text messages, and include hundreds of participating devices. During the online chat session, different topics can be discussed, questions asked, and answers given.

User interfaces are typically organized to display each exchanged text message and an identifier of the user sending a corresponding text message. The displayed text messages are displayed chronologically as they are received. Scrolling capabilities allow users of the devices to scroll through past text messages, typically using a swipe gesture. Some user interfaces include a search capability that allows a user to search the chat messages.

Some online chat session user interfaces have added transmission and display of objects in addition to entered text, such as charts, graphs, photographs, videos, etc., generated by other applications and selected by a user to include in the exchanged message. The object is typically displayed in line with the text as an icon, a miniaturized display, or a link. Selecting the object icon, miniaturized display, or link can expand to a pop-up view of the object.

### BRIEF SUMMARY

In one aspect of the present invention, a computer-implemented method for creating a chat session dynamic user interface includes executing a computer processor identifying a conversation in a chat session between a plurality of computing devices, wherein the conversation is defined by text messages that include a question and a plurality of responses to the question, analyzing content of the identified conversation to determine a type of the question, select a template according to the type of the question, generating a user interface display according to the selected template and the content of the conversation, wherein the selected template is populated with a summary of the plurality of responses, and distributing the generated user interface display to a user interface of each of the plurality of computing devices according to the selected template.

In another aspect, a system has a hardware computer processor, computer readable memory in circuit communication with the computer processor, and a computer-readable storage medium in circuit communication with the computer processor and having program instructions stored thereon. The computer processor executes the program instructions stored on the computer-readable storage medium via the computer readable memory and thereby creates a chat session dynamic user interface, which identifies a conversation in a chat session between a plurality of computing devices, wherein the conversation is defined by text messages that include a question and a plurality of responses to the question, analyzes content of the identified conversation to determine a type of the question, select a template according to the type of the question, generates a user interface display according to the selected template and the content of the conversation, wherein the selected template is populated with a summary of the plurality of responses, and distributes the generated user interface display to a user interface of each of the plurality of computing devices according to the selected template.

In another aspect, a computer program product for creating a chat session dynamic user interface has a computer-readable storage medium with computer readable program code embodied therewith. The computer readable program code includes instructions for execution by a computer processor that cause the computer processor to identify a conversation in a chat session between a plurality of computing devices, wherein the conversation is defined by text messages that include a question and a plurality of responses to the question, analyze content of the identified conversation to determine a type of the question, select a template according to the type of the question, generate a user interface display according to the selected template and the content of the conversation, wherein the selected template is populated with a summary of the plurality of responses, and distribute the generated user interface display to a user interface of each of the plurality of computing devices according to the selected template.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 depicts an example schematic illustration of an embodiment of the present invention.

FIG. 5 is a flow chart illustration of an embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

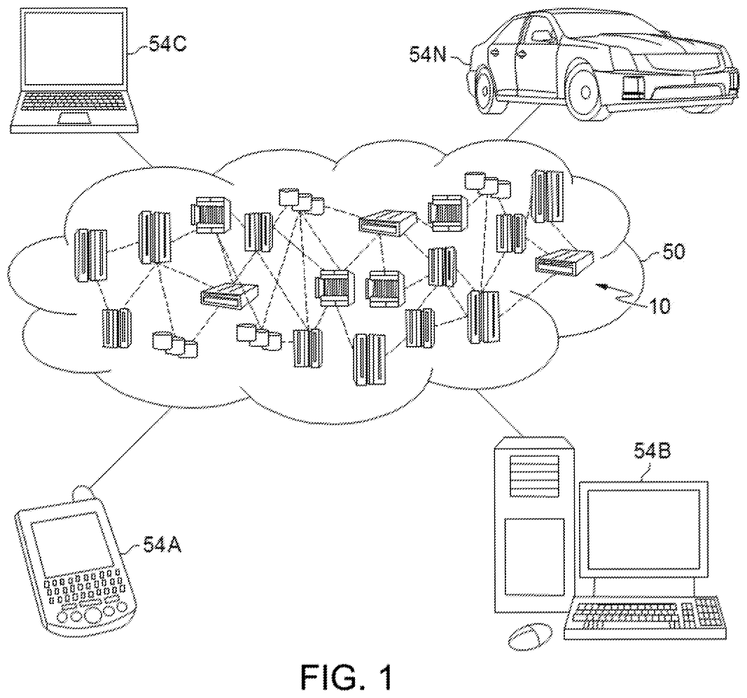

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

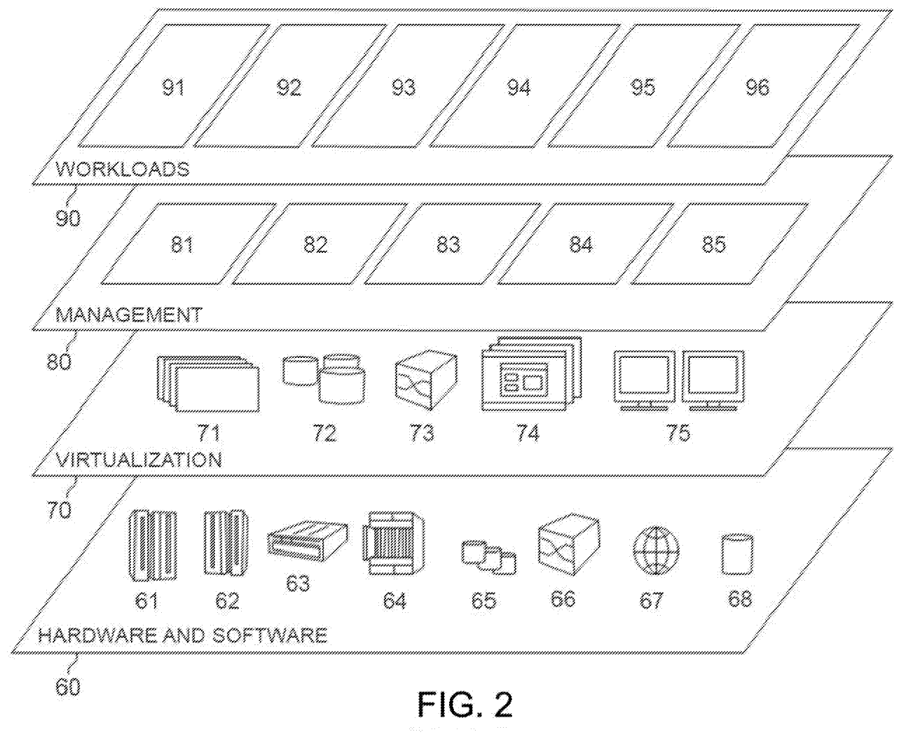

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for creating a chat session dynamic user interface 96.

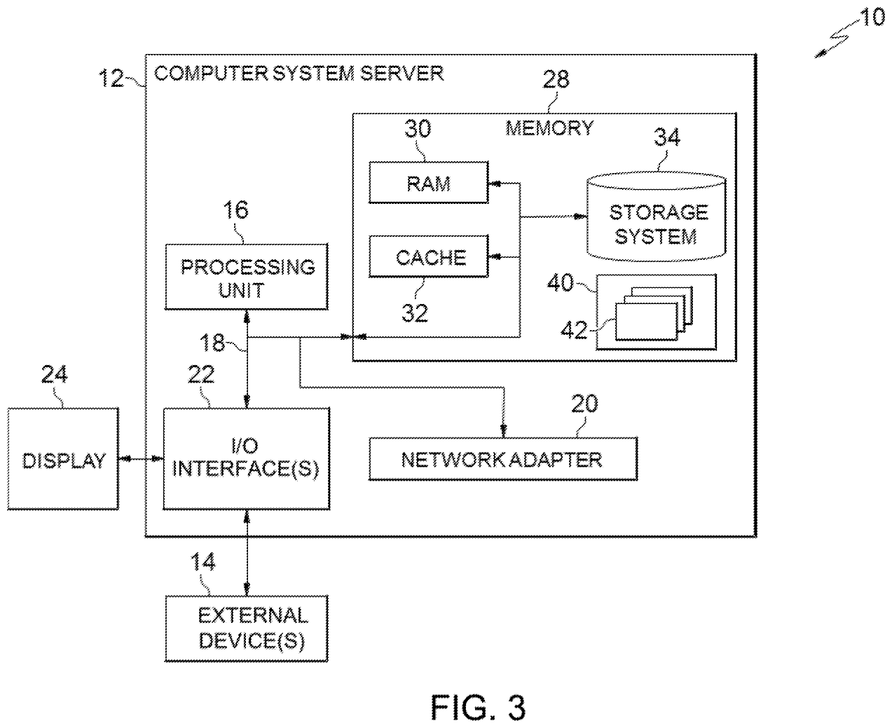

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

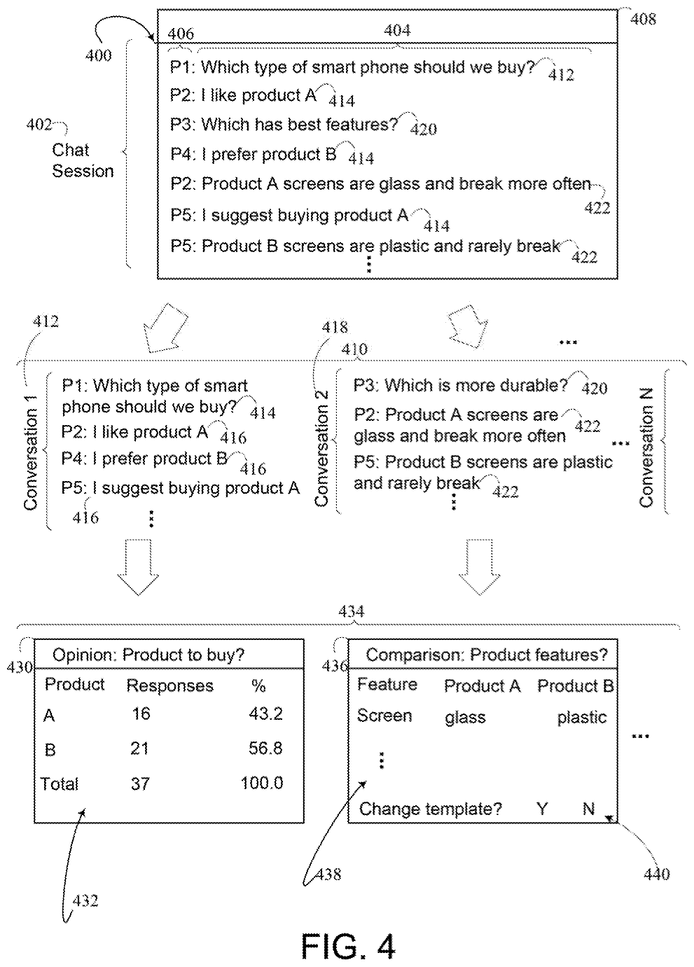

FIG. 4 schematically illustrates an example according to the present invention for a chat session dynamic user interface. A configured processor, such as the processing unit 16, as described in reference to FIG. 3, receives text messages 400 in real-time within a chat session 402. In some embodiments, the configured processor can also include a suitably configured processor on the local computing device 54, such as with an application plug-in.

Each text message 400 includes text 404 and an identifier 406, such as a name, phone number, email address, or description of an entity operating the local computing device 54 or an identifier of the sending local computing device 54. The text messages 400 of the chat session 402 are displayed on a display device of each local computing device 54 as the text messages 400 are received. The display device, such as the display 24 described in reference to FIG. 3, includes a user interface with a window 408 that displays each message 400 chronologically in real-time as each text message 400 is received.

The configured processor uses natural language processing to identify conversations 410 in the chat session 402. The conversations 410 are defined by a question and responses to that question. Each of the questions and the responses are identified from the text of the text messages 400. For example, a first conversation 412 is defined by a first question 414 of “Which type of smart phone should we buy?” from a sending device of P1, where P1 is the identifier 406. Responses 416 to the first question 412 indicate opinions responsive to whether to buy product A or product B by corresponding sending users P2, P4 and P5. A second conversation 418 is defined by a second question 420 of “Which has the best features?” from a sending device of P3 and responses 422 indicating features of the corresponding product A and product B from P2 and P5, respectively. The text messages 400 of the conversations 410 can interleave in order. That is, the responses 414 to the first question 412 can be received before and/or after the second question 420 and before and/or after the responses 422 to the second question 420.

The configured processor, using the natural language techniques, identifies corresponding responses to the question based on the content of the question and the content of each response. In the memory 28, the text messages 400 are distinguished by the conversation 410. For example, a tag identifying the conversation 410 can be added to each text message in an array, a linked list formed, etc. for each conversation 410.

At a predetermined threshold in each conversation 410, the configured processor analyzes the content, and thereby determines the type of question and selects a template based on the type of question. The predetermined threshold can be based on a counter of responses for the conversation 410, a timer for the duration between a first response and a last response for the conversation 410, a counter of the text messages 400 between the first response and the last response for the conversation 410, a counter of conversations 410, and combinations thereof.

The type of question can include an opinion poll, a geographic query and a comparative analysis. The type of question indicates a template, which can be selected from a ranked group of templates. For example, an opinion poll can be presented in individual templates as a statistical frequency table, a pie chart, or a bar graph, and the individual templates rank ordered. Attributes for the ranking can include counts of responses, counts of classified types of responses, and feedback,

The configured processor uses a model to analyze the content of each conversation 410 and select a template. The model can include deep learning models, support vector machines, Bayesian networks, neural networks, linear regression models, long short term memory (LSTM), and the like, to select the template. The model can be trained using a collection of chat sessions and initial expert selected templates. The model can be trained to select a ranked template from a plurality of templates for each type of question. The model can learn to change ranking based on feedback.

The templates include predetermined forms, such as tables, graphs, charts, and the like, selected according to the type of content and populated from the analyzed content. For example, in some embodiments, opinions indicate forms, such as a table, a pie chart, a bar chart, a grid or a histogram; geographic locations indicate forms, such as different types of maps, such as a political map, surface map, satellite map, highway map or a city map; feature comparison indicate forms, such as a table, a bar chart, a pie chart, a grid or a histogram.

In the illustrated example, the model for the first conversation 410 identifies an opinion template 430, which is structured in a form of a statistical frequency table 432. The configured processor generates a pop-up window 434 for the user interface for each conversation 410 that satisfies the predetermined threshold. The configured processor populates the form of the selected template according to the responses from the conversation 410. For example, the configured processor populates the frequency table 432 of the opinion template 430 with frequency statistics of the classified types of the responses 414 to the first question 412. The pop-up window 434 is a separate window of the user interface from the window 408 displaying the text messages 400. The first question 412 is reformatted, and reduced to a topic question of a “Product to buy?” by the model. The topic question is displayed in a header of a first pop-up window according to the opinion template 430.

In some embodiments, the selected template can include drill down capabilities. For example, within an input selecting the 16 favorable responses for product A in the frequency table 432, the pop-up window 434 or another pop-up window lists the 16 responses. In some embodiments, the selection highlights the responses in the window 408 of the text messages.

The model identifies a comparative template 436 for the second conversation 418 as the corresponding threshold is reached. The comparative template 436 is structured in a form of a grid 438. The grid 438 includes features along the vertical axis and products across the horizontal axis. Each cell of the grid 438 includes the feature according to the corresponding product. For example, the cell of product A for the feature of the screen is “glass.” The cell of product B for the feature of the screen is “plastic.” The comparative template 438 is populated with information from the second conversation 418, such as the responses 422 from P2 and P5, respectively, regarding the different types of screens used in smartphones.

The template can include a feedback mechanism 440, which receives feedback on the form used in the template. The feedback mechanism 440 can include inputs indicating preferences for types of forms, or simply an input whether to change the form, such as Y/N, icons for thumbs up or thumbs down, and the like. The feedback mechanism 440 provide inputs to the model, which allow the model to learn and change the ranking of the templates for selection.

The configured processor distributes the pop-up windows 434 to each of the local computing devices 54 as each pop-up window 434 is generated. In some embodiments, the template is updated periodically and redistributed. The periodic update can be triggered based on counts of additional responses from the last distribution, a time period from the last distribution, percentage changes in categories of responses from the last distribution, and combinations thereof.

The pop-up window 434 is displayed on the display device of each local computing device 54 participating in the chat session 402. In some embodiments, the pop-up window 434 can be indicated in line with the text messages 400 as an icon within a text message from the system, which when selected displays the distributed pop-up window 434. In some embodiments, the pop-up window 434 is indicated as an icon in the header or footer of the window 408, which when selected displays the distributed pop-up window 434. In some embodiments, the pop-up window 434 is displayed as an overlay window. In some embodiments, chat session preferences according to each local computing device 54 control which of the in-line message, the header/footer icon, or the overlay is employed.

The identification of the conversations 410, the selecting of a template according to a model processing the content of the text messages 400, the generating of the pop-up window 434 according to the selected template and the content of the text messages 400, and the distribution of the pop-up window 434 to each local computing device provide improvements over the conventional practice of searching and scrolling through the text messages 400 by individual users of the local computing devices 54. The selected templates provide a summary of the content of the chat session 402 in a structured form, which allows users of the local computing devices 54 to analyze and synthesize content of separate conversations, particularly for chat sessions 402 with large numbers of participating users, large numbers of text messages, extended periods of time, and combinations thereof. That is, the text messages 400 are not conventionally identified by conversation, are not conventionally structured except in chronological order, and are not conventionally summarized. The distributed pop-up window 434, distributed to each local computing device 54, can provide a shared understanding, which contrasts over the conventional practice of individualized or non-shared searching and scrolling.

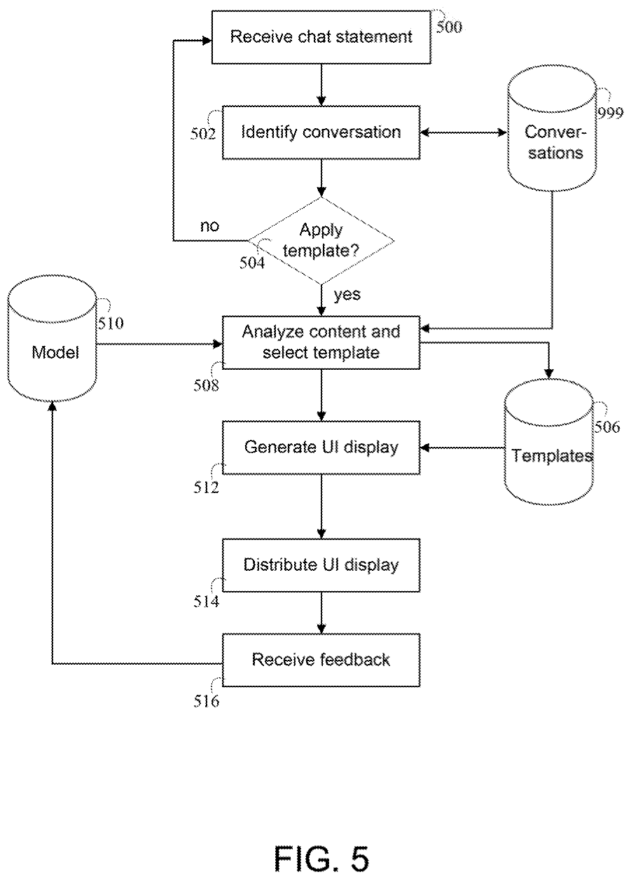

FIG. 5 illustrates one embodiment of a method according to the present invention for a chat session dynamic user interface. At 500, the configured processor receives the text message 400 in the chat session 402. The chat session 402 includes the text messages 400 exchanged by computing devices, such as the local computing devices 54.

At 502, the configured processor identifies the conversation 410 for the received text message 400. Each conversation 410 is defined by text messages that include a question and responses to the question. The configured processor can tag or segregate in the memory 28, the corresponding conversation 410 for the received text message 400. For example, if the text message includes a question, a new conversation can be added. If the text message includes a response, an existing conversation can be matched according to the topic.

At 504, the configured processor determines whether a predetermined threshold for the conversation 410 has been met and a template 506 is to be selected. Examples of the predetermined threshold include a count of responses for the conversation 410, a time duration between a first response and a last response for the conversation 410, a count of all the text messages 400 between the first response and the last response for the conversation 410, a count of the conversations 410, and combinations thereof. In response to the predetermined threshold not being met, the method resumes at 500.

At 508, the configured processor, in response to the predetermined threshold being met, analyzes content of the identified conversation by a model 510. The model 510, such as a deep learning model, support vector machines, Bayesian networks, neural networks, linear regression models, long short term memory (LSTM), and the like, receives and inputs the text messages for the conversation 410 and outputs an identifier of the selected template 506 for displaying the analyzed content. The model 510 analyzes the content to determine the type of question and select the template according to the type of question, such as an opinion poll, a geographic query and a comparative analysis.

At 512, the configured processor generates the pop-up window 434 or user interface display according to the selected template 506 and the content of the conversation 410. The selected template 506 can be retrieved from a collection of templates stored in the memory 28 according to the identifier output by the model 510. The template structures the content of the text messages from the conversation 410, and populates a form of the template. In some embodiments, the model includes further outputs, which can be used to populate the form of the selected template 506, such as the topic question, response categories, response frequency statistics, etc. The forms of the selected template 506 can include a statistical summary table, a graph, a chart, a map, a grid, and the like.

At 514, the configured processor distributes the generated user interface display to the user interface of each of the computing devices. The generated display or pop-up window 434 is populated according to the selected template. That is, each computing device receives the generated display from the cloud 50, such as in service based in a cloud environment. In some embodiments, the generated display is received from a same node 10 that distributes the text messages 400. In some embodiments, the generated display is received from a different node that distributes the test messages 400, such as on a different channel.

For example, in the conversation 410, which includes geographic locations, a map template is selected, and the geographic locations are indicated on the map. The map can be scaled. Responses can be scaled, rounded, or interpreted to fit in the selected template. For example, a response of “a few” can be assigned a default number. With a map, a response to a question of “where can I find a grocery store closest to 50 Albany St.?,” may be interpreted to locate a point on the map geographically 4 blocks north of 50 Albany St, which is 50 Lowell St. The point is placed at 50 Lowell St. rather than at 50 Albany St.

At 516, the configured processor receives feedback from the computing devices using the feedback mechanism 440. The feedback can be used as a further input to the model 510 in the selection of a template. In some embodiments, the feedback mechanism includes responses of a selection from a ranked list of template alternatives according to statistical confidence levels determined by the model 510. In some embodiments, the feedback mechanism includes positive or negative responses to the generated display being displayed on the computing device.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for creating a chat session dynamic user interface, comprising executing on a computer processor:
identifying a conversation in a chat session between a plurality of computing devices, wherein the conversation is defined by text messages that include a question and a plurality of responses to the question;
analyzing content of the identified conversation to determine a type of the question;
selecting a template according to the determined type of the question;
generating a user interface display according to the selected template and the content of the conversation, wherein the selected template is populated with a summary of the plurality of responses; and
distributing the generated user interface display to a user interface of each of the plurality of computing devices according to the selected template.

2. The method of claim 1, further comprising:
displaying the distributed user interface display on a display device of each of the plurality of computing devices, wherein the distributed user interface display is displayed in a different window of the user interface on each display device.

3. The method of claim 1, further comprising:
measuring the conversation based on a measure selected from a group consisting of a count of responses, a time duration between a first response and a last response, a count of text messages between the first response and the last response, and a count of conversations, wherein the measure is compared with a predetermined threshold for the conversation.

4. The method of claim 1, wherein the analyzed content of the conversation includes opinions about a topic; and
wherein the template includes a graphic chart of frequency measures of the responses by opinion, wherein the graphic chart is selected from a rank ordered group consisting of a table, a bar chart, a pie chart, a grid, and a histogram.

5. The method of claim 1, wherein the analyzed content of the conversation includes geographic locations present in the responses; and
wherein the template includes a map of the geographic locations, wherein the map is selected from a rank ordered group consisting of a political map, surface map, satellite map, highway map, and a city map.

6. The method of claim 1, wherein the analyzed content of the conversation includes a comparison selected from a group consisting of a plurality of products, a plurality of services, a plurality of locations, and a plurality of events; and
wherein the selected template includes a graphic chart representing the features of the comparison from the plurality of responses, wherein the graphic chart is selected from a rank ordered group consisting of a table, a bar chart, a pie chart, a grid, and a histogram.

7. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer readable storage medium via the computer readable memory and thereby identifies a conversation in a chat session according to a question, analyzes the content of the identified conversation, generates the user interface display, and distributes the generated user interface display to each of the plurality of computing devices.

8. The method of claim 7, wherein the computer-readable program code is provided as a service in a cloud environment.

9. A system for creating a chat session dynamic user interface, comprising:
a computer processor;
a computer readable memory in circuit communication with the computer processor; and
a computer readable storage medium in circuit communication with the computer processor;
wherein the computer processor executes program instructions stored on the computer readable storage medium via the computer readable memory and thereby:
identifies a conversation in a chat session between a plurality of computing devices, wherein the conversation is defined by text messages that include a question and a plurality of responses to the question;
analyzes content of the identified conversation to determine a type of the question;
selects a template according to the determined type of the question;
generates a user interface display according to the selected template and the content of the conversation, wherein the selected template is populated with a summary of the plurality of responses; and
distributes the generated user interface display to a user interface of each of the plurality of computing devices according to the selected template.

10. The system of claim 9, wherein the processor executes program instructions stored on the computer readable storage medium via the computer readable memory and thereby:
displays the distributed user interface display on a display device of each of the plurality of computing devices, wherein the distributed user interface display is displayed in a different window of the user interface on each display device.

11. The system of claim 9, wherein the processor executes program instructions stored on the computer readable storage medium via the computer readable memory and thereby:
measures the conversation based on a measure selected from a group consisting of a count of responses, a time duration between a first response and a last response, a count of text messages between the first response and the last response, and a count of conversations, wherein the measure is compared with a predetermined threshold for the conversation.

12. The system of claim 9, wherein the analyzed content of the conversation includes opinions about a topic; and
wherein the template includes a graphic chart of frequency measures of the responses by opinion, wherein the graphic chart is selected from a rank ordered group consisting of a table, a bar chart, a pie chart, a grid, and a histogram.

13. The system of claim 9, wherein the analyzed content of the conversation includes geographic locations present in the responses; and
wherein the template includes a map of the geographic locations, wherein the map is selected from a rank ordered group consisting of a political map, surface map, satellite map, highway map, and a city map.

14. The system of claim 9, wherein the analyzed content of the conversation includes a comparison selected from a group consisting of a plurality of products, a plurality of services, a plurality of locations, and a plurality of events; and
wherein the selected template includes a graphic chart representing the features of the comparison from the plurality of responses, wherein the graphic chart is selected from a rank ordered group consisting of a table, a bar chart, a pie chart, a grid, and a histogram.

15. A computer program product for creating a chat session dynamic user interface, the computer program product comprising:
a computer readable storage medium having computer readable program code embodied therewith, the computer readable program code comprising instructions for execution by a computer processor that causes the computer processor to:
identify a conversation in a chat session between a plurality of computing devices, wherein the conversation is defined by text messages that include a question and a plurality of responses to the question;
analyze content of the identified conversation to determine a type of the question;
select a template according to the determined type of the question;
generate a user interface display according to the selected template and the content of the conversation, wherein the selected template is populated with a summary of the plurality of responses; and
distribute the generated user interface display to a user interface of each of the plurality of computing devices according to the selected template.

16. The computer program product of claim 15, wherein the instructions for execution cause the computer processor to:
display the distributed user interface display on a display device of each of the plurality of computing devices, wherein the distributed user interface display is displayed in a different window of the user interface on each display device.

17. The computer program product of claim 16, wherein the instructions for execution cause the computer processor to:
measure the conversation based on a measure selected from a group consisting of a count of responses, a time duration between a first response and a last response, a count of text messages between the first response and the last response, and a count of conversations, wherein the measure is compared with a predetermined threshold for the conversation.

18. The computer program product of claim 15, wherein the analyzed content of the conversation includes opinions about a topic; and
wherein the template includes a graphic chart of frequency measures of the responses by opinion, wherein the graphic chart is selected from a rank ordered group consisting of a table, a bar chart, a pie chart, a grid, and a histogram.

19. The computer program product of claim 15, wherein the analyzed content of the conversation includes geographic locations present in the responses; and
wherein the template includes a map of the geographic locations, wherein the map is selected from a rank ordered group consisting of a political map, surface map, satellite map, highway map, and a city map.

20. The computer program product of claim 15, wherein the analyzed content of the conversation includes a comparison selected from a group consisting of a plurality of products, a plurality of services, a plurality of locations, and a plurality of events; and
wherein the selected template includes a graphic chart representing the features of the comparison from the plurality of responses, wherein the graphic chart is selected from a rank ordered group consisting of a table, a bar chart, a pie chart, a grid, and a histogram.
